(19) United States
(12) Patent Application Publication
(10) Pub. No.: US 2010/0082414 A1
(43) Pub. Date: Apr. 1, 2010

(54) DISPLAY DEVICE AND CONTROL METHOD FOR THE SAME

(75) Inventor: Tomoyuki Shimaya, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/490,975

(22) Filed: Jun. 24, 2009

(30) Foreign Application Priority Data
Sep. 26, 2008 (JP) 2008-248324

(51) Int. Cl. G06F 1/32; G06Q 30/00

(52) U.S. Cl. 705/14.4; 700/295; 715/772

(57) ABSTRACT

According to one embodiment of the present invention, a display device is configured to select an arbitrary mode among a plurality of types of power saving modes to effect performance of the display device in response to a taste. The display device achieves power saving cooperation. A setting storage module is configured to store setting states of the types of power saving modes. A display output module responds to an operation input to display the on, off, or selection states of the types of power saving modes. An execution change control module responds to the operation input to individually change the release or continuation of each type of the power saving modes. The execution change control module forcibly executes the types of power saving modes when a predetermined condition is met.

### CROSS-REFERENCE TO RELATED APPLICATIONS

This application is based upon and claims the benefit of priority from Japanese Patent Application No. 2008-248324, filed Sep. 26, 2008, the entire contents of which are incorporated herein by reference.

### BACKGROUND

1. Field

One embodiment of the invention relates to a display device and a control method for the same, which contribute to power saving and take a user's taste or preferences into consideration.

2. Description of the Related Art

A technique, by which a server of a power company transmits power saving information in response to a season and a time zone, and clients use the power saving information for saving power, has been disclosed (see Japanese Patent No. 3730614). In this technique, the clients receive information on a power saving time zone transmitted from the server of the power company. The user then sets a time to start power saving depending on the range of the power saving time zone. When it reaches the time to start the power saving, the clients control secondary batteries and external power sources, and the clients are forcibly brought into power saving modes.

Meanwhile, in the foregoing technique, the server of the power company divides a plurality of types of clients into groups in advance, and allocates the power saving time zone to each group so as to shift a time zone of a power feeding peak. When it has reached the power saving time zone, the clients forcibly switch the modes into states of charging prohibition of the batteries and use states of power sources of the batteries.

However, in the conventional technique, the server has to integrally manage a large number of clients. When it has reached the power saving time zone, the clients are forcibly shifted into the power saving modes.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary configuration view depicting a display device with the invention applied thereto;

FIG. 2 is an exemplary flowchart depicting characteristic basic operations of the display device of FIG. 1;

FIGS. 3A to 3C are exemplary views depicting aspects of videos on displays 240 when confirming setting states of a plurality of types of power saving modes to newly apply setting and correction changes to and in the setting sates;

FIG. 4 is an exemplary flowchart depicting operations when the plurality of types of power saving modes are forcibly executed at once by means of a power mode execution and change control module 420;

FIGS. 5A and 5B are exemplary views depicting that power saving modes are currently in execution and aspects in which messages for confirming the power saving modes now in execution and tables showing the execution states of the power saving modes are displayed on the displays 240;

FIG. 6 is an exemplary flowchart depicting an operation example of the display device when a condition to shift to the power saving mode has been set, for example, to a predetermined period;

FIG. 7 is an exemplary flowchart depicting an operation example of another embodiment of the invention;

FIG. 8 is an exemplary view depicting examples of a plurality of types (12 types) of items of power saving mode information in a table;

FIG. 9 is an exemplary view depicting an aspect in which the table depicted in FIG. 8 is partially displayed on the display 240;

FIG. 10 is an exemplary view depicting an aspect in which power saving mode setting information is associated with programs, commercial messages, external inputs, and viewing by multiple viewers, respectively; and

FIG. 11 is an exemplary flowchart depicting an operation example when the power saving mode setting information depicted in FIG. 10 is utilized.

### DETAILED DESCRIPTION

Various embodiments according to the invention will be described hereinafter with reference to the accompanying drawings.

One embodiment of the present invention provides a display device and a control method for the same configured to set a plurality of types of power saving modes, let a user select power saving modes, and take viewer's tastes or preferences into consideration without being restricted in power saving time zone.

The embodiment has a power saving mode setting storage module for setting and storing on, off, or selection states of the plurality of types of power saving modes, a power saving mode state display output module showing the on, off or selection states of the plurality of types of power saving modes, and a power saving mode change control module changing the plurality of types of the power saving modes in response to operation inputs.

The display device of the embodiment has a power saving mode execution module which executes the plurality of types of power saving modes when a predetermined condition is met.

A user of the display device of the embodiment may select an arbitrary mode among the plurality of types of power saving modes, and take advantage of the performance of the display device in response to the user's taste while achieving power saving in cooperation with other users.

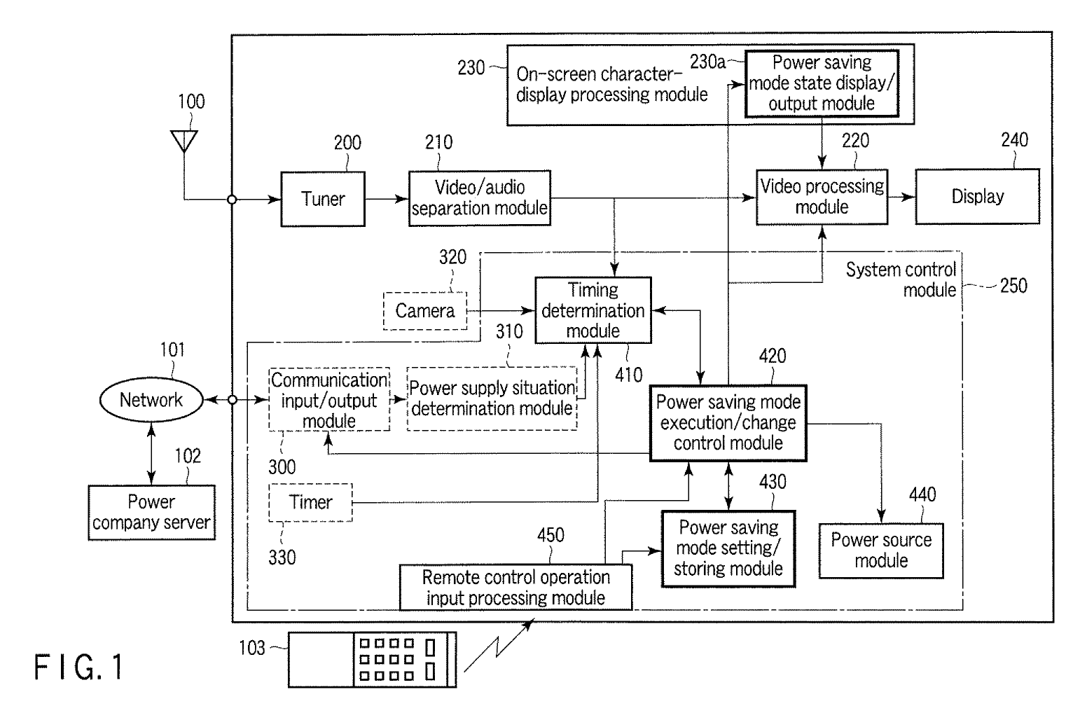

The embodiment will now be described in further detail. FIG. 1 shows a display device to which the invention is applied, which shows, for example, a television receiver. An antenna 100 receives electric waves. A tuner 200 selects a reception channel, demodulates a broadcasting signal included in the reception channel, and outputs the demodulated signal. The demodulated signal is input to a video audio separation processing module 210, and a video signal is input to a video processing module 220. The video signal processed by the video processing module 220 is input to a display 240 to be displayed. While the display device includes an audio signal system, the audio signal system is omitted herein.

Data such as characters and figures from an on-screen character-display processing module 230 is input to the video processing module 220. As regards the data of the characters and figures, program guide information, or power saving mode information and a message given later are usable. Therefore, the display processing module 230 includes a power saving mode state display output module 230a. The output module 230a will be explained in detail later.

Although a block 250 means a system control module of this digital display device, the block 250 illustrates a functional block especially related to the invention.

A communication input output module 300 may receive power saving information from a power company server 102 via a network 101. The power saving information includes information such as power supply information showing, for example, a tight amount of power supply.

The received power saving information is input to a power supply situation determination module 310. When receiving the amount information, the situation determination module 310 supplies the amount information to a timing determination module 410. If the amount information shows a prescribed condition, the timing determination module 410 transmits a detection signal to a power saving mode execution and change control module 420.

A case in which the amount information shows the prescribed condition means, for example, a case in which information showing that the amount of power supply from the power company has become tight or has become a relief, is received.

When receiving the detection signal, the control module 420 may shift the display device into a plurality of types of power saving modes. The time point when control module 420 decides to shift into the plurality of types of power saving modes is not necessarily limited to a time point when the control module 420 has received the detection signal.

A large number of the plurality types of power saving modes are available. As regards “a plurality of types of power saving modes”, they include, for example, items as follows:

(1) As regards a luminous level, the luminous level is forcibly controlled to become lower than a set value

(2) In a case of no operation for a predetermined time interval (e.g., 60 minutes or 120 minutes), the main power of the display device is turned off

<The timing determination module 410 can determine whether no operation has been performed for the predetermined time interval by monitoring the output from a timer 330>

(3) If a viewer is absent for longer than a predetermined time interval, the main power is turned off, and if the viewer is detected, the main power is turned on

<In the above case of (2) or (3), the control module 420 outputs a command signal to a power source control module 440. The timing determination module 410 analyzes an input video from a camera 320 to confirm whether the presence or absence of the viewer (a moving image is usable for the confirmation)>

Turn off a noise reduction function

Switch over a frame frequency 120 Hz of a double-speed display to 60 Hz

(6) Set so as not to acquire program information during standby

(7) Lower a power source level, for example, of a demodulation unit when no signal is present during on-air

(8) Lower power a source level, for example, of an external interface and a recognition unit when no signal is input externally

(9) Turn off USB power if the USB is not in use

(10) Turn off power of a BS tuner unit if the BS tuner unit is not in use

(11) Turn off power of a CS tuner unit if the CS tuner unit is not in use

(12) Turn off power of a terrestrial digital broadcast tuner unit if the terrestrial digital broadcast tuner is not in use

(13) Turn down an audio output.

When the plurality types of power saving modes of the above are executed at once regardless of the intention of the viewer, there is a case where the viewer is not satisfied due to his or her taste. For instance, there may be a case where a power saving mode such as “lower the luminosity level so as the level becomes lower than a set value, turn off a noise reduction function, and switch over a frame frequency 120 Hz of a double-speed display to 60 Hz” is not desired to be executed”.

In such a case, the display device of the embodiment may be set to select on/off of the power saving modes. That is, the display device may be set to permit or prohibit execution of the power saving mode for each type of the power saving modes.

The setting state of the power saving modes of the above is stored in a power saving mode setting storage module 430. The setting information of on/off of the power saving modes is generated when the viewer operates a remote controller 103. The operation information from the remote controller 103 is input to the setting storage module 430 through a remote controller operation input processing module 450. When the setting and storing of the power saving mode are performed, a menu screen of the power saving modes is displayed on the display 240. This display state will be described in detail later.

The control module 420 may change the setting information of various types of power saving modes. The changed setting information of the various power saving modes is stored again in the setting storage module 430.

When the power saving mode display operation is performed, the setting information of the various types of power setting modes is input to the output module 230a through the control module 420. The setting information of the various types of power saving modes is input to the display 240 through the video processing module 220 and the setting information is displayed on the display 240.

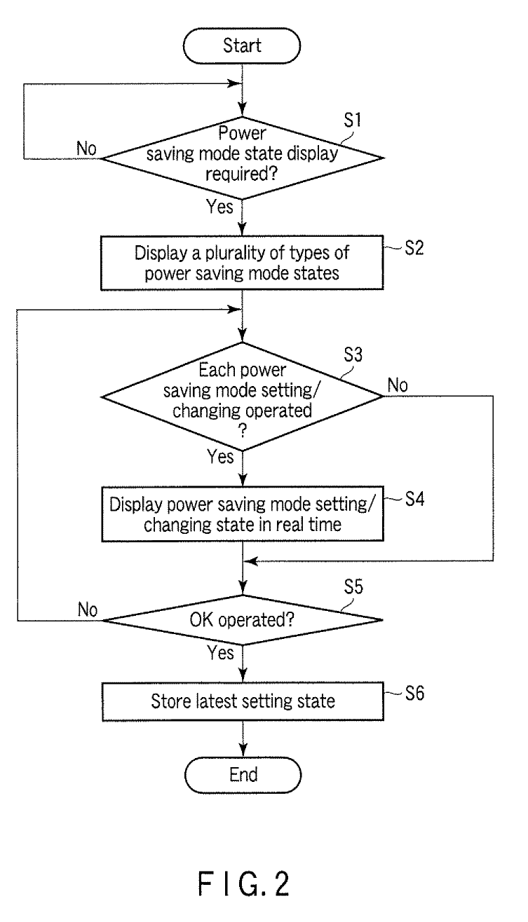

FIG. 2 shows a flowchart illustrating typical basic operations of the display device of FIG. 1. The viewer is able to operate the remote controller 103 to display the power saving mode state on the display 240 (Steps S1 and S2). The viewer is able to recognize the setting state of the displayed plurality of types of power saving modes, and conduct new setting, a correction, and a change (Step S3). The new setting, correction and change are displayed on the display 240 in real time.

Here, if the viewer operates an “OK” button of the remote controller 103, the latest setting state is stored in the setting storage module 430.

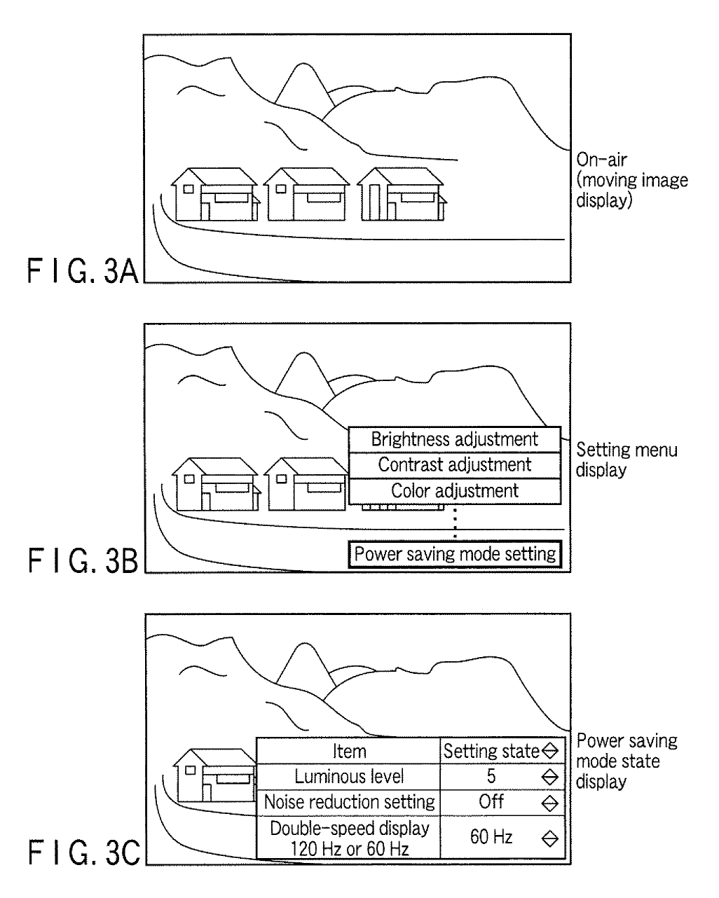

FIGS. 3A-3C show aspects of videos on the displays 240 when confirming the setting states of the plurality of types of power saving modes to perform new setting, corrections and changes. It is assumed that FIG. 3A currently shows a display of a moving image during on-air. Here, if the viewer selects to operate an adjustment item menu button, a table of various adjustment items is displayed as shown in FIG. 3B. Among the items, there is an item of “power saving mode setting”. The viewer moves a cursor on a screen while operating the remote controller 103 to select the item of “power saving mode setting”. If the viewer operates the “OK” button, the state of the currently set power saving mode is displayed as shown in FIG. 3C. In this example, the luminous level is set to a level “5” out of “1” to “10” levels. The noise reduction function is turned “off”. The frame frequency of the double-speed display is set to 60 Hz. Further, to confirm the setting state of the power saving mode of another type, the viewer is able to operate the cursor and confirm the setting state by scrolling the table of the adjustment items.

Here, there may be some cases in which the viewer wants to change the luminous level, noise reduction, and frame frequency depending on the program content. In such cases, the viewer may arbitrary select the luminous levels, the on/off of the noise reduction, and frame frequency by operating the keys of the remote controller 103. For instance, by operating the “next” button of the remote controller 103 by setting the cursor to a desired item, the setting content is changed. When the desired setting content is displayed, operating the decision button sets the desired setting content. Next, the viewer operates the cursor button and may move the cursor to a position of another adjustment item. After setting and changing, if the viewer operates the “OK” button of the remote controller 103, the latest setting state is stored in the setting storage module 430. At this moment, the setting state may be stored in association with the name of the program and the time zone information.

The plurality of types of power saving modes, which have been set as mentioned above, are forcibly executed at once by the control module 420 when the predetermined condition is achieved.

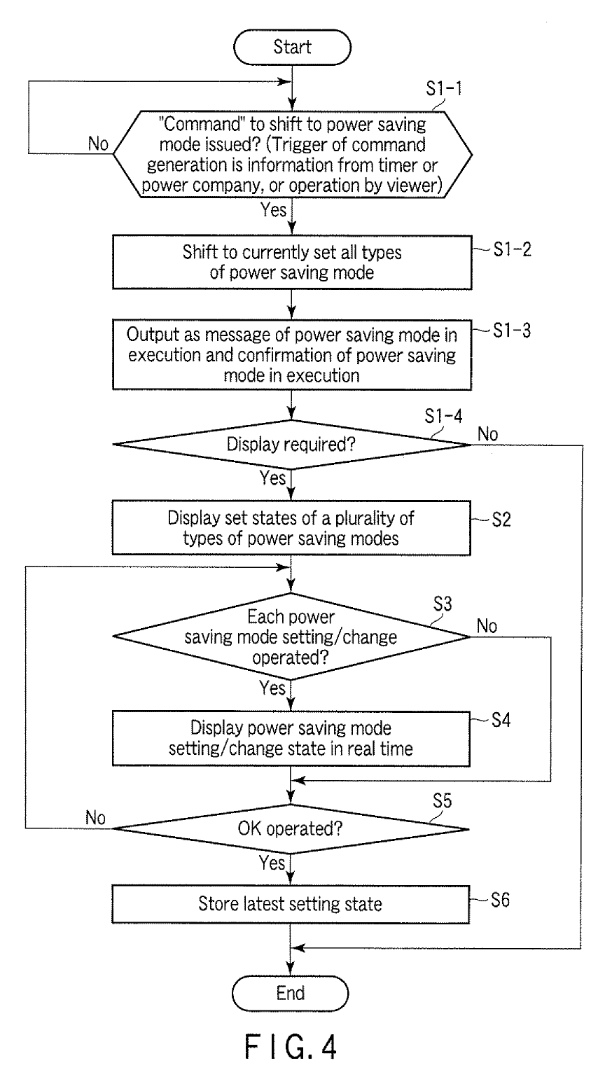

FIG. 4 shows operations when a plurality of types of power saving modes are forcibly executed at once by means of the control module 420. That is, if there is a “command” to shift the mode into the power saving mode (Step S1-1), the display device shifts the mode to all the types of power saving modes which are currently set (Step S1-2). Next, the control module 420 sends a message that now the control module 420 executes the power saving mode and that the power saving mode in execution may be confirmed. That is, a display of “execution of a power saving mode and a type of the power saving mode may be confirmed” may be performed.

Accordingly, the viewer is able to issue a display request for the forgoing display in order to recognize which of the power saving modes has been executed (Step S1-4). For instance, the operation of the menu key of the remote controller 103 may be conducted by operating the menu key of the remote controller 103. The operation enables displaying the state of the set plurality of types of power saving modes (Step S2). The processing after Step S2 is the same as the content described in FIG. 2.

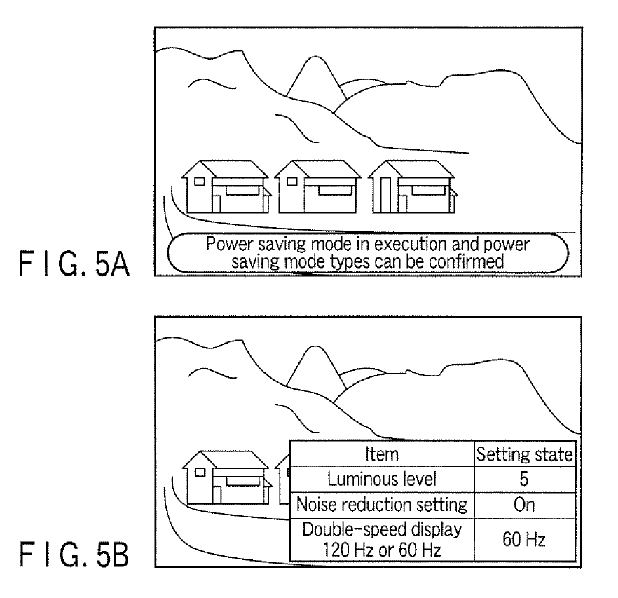

FIG. 5A shows an aspect that the power saving mode is currently in execution in the state of Step S1-3, and that the display 240 has displayed the message enabling confirmation of the power saving mode in execution. FIG. 5B shows an aspect that the display request has made in Step S1-4 and that the display of Step S2 has achieved.

Various display forms of the table showing the states of the power saving modes are available in FIGS. 3A-3C and FIGS. 5A-5B. In recent years, since screens have enlarged, the display area of the table can be extended as well as the video area, such as an on-air image area and reproduced image area. For instance, the table can be displayed on a data broadcast screen. If the video area is full-screen, a part displaying the video may be switched to a window screen, and the table may be displayed on the area other than the window screen.

Meanwhile, to shift into the power saving mode, various conditions may be set. Setting to omit a part of conditions of a transition to the power saving mode may be performed.

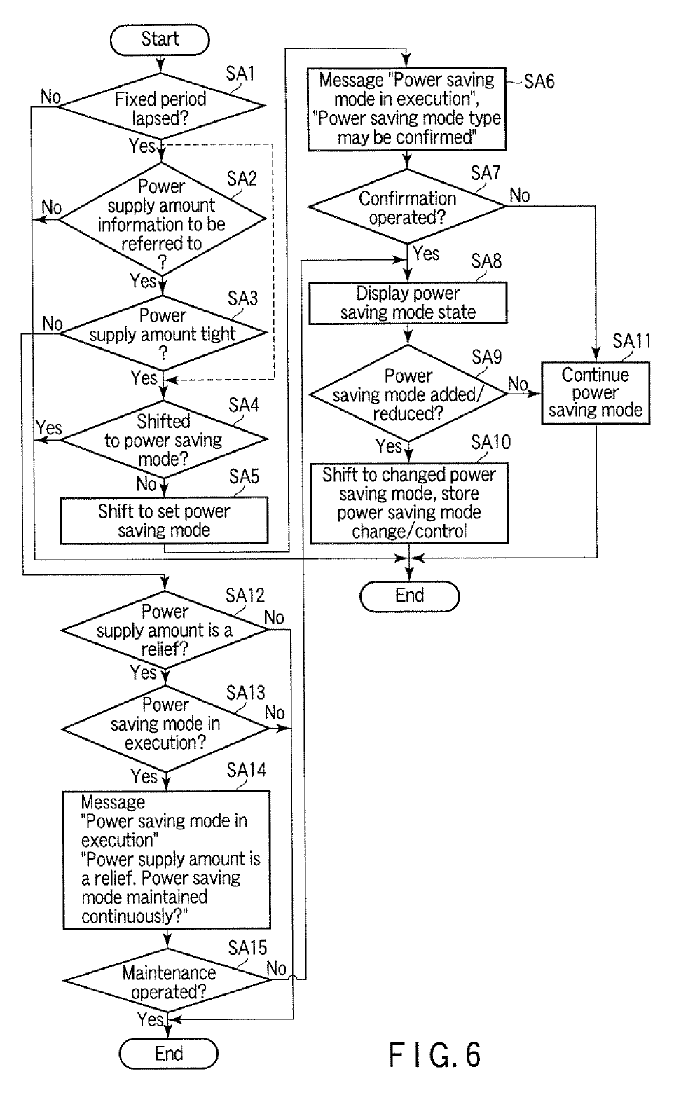

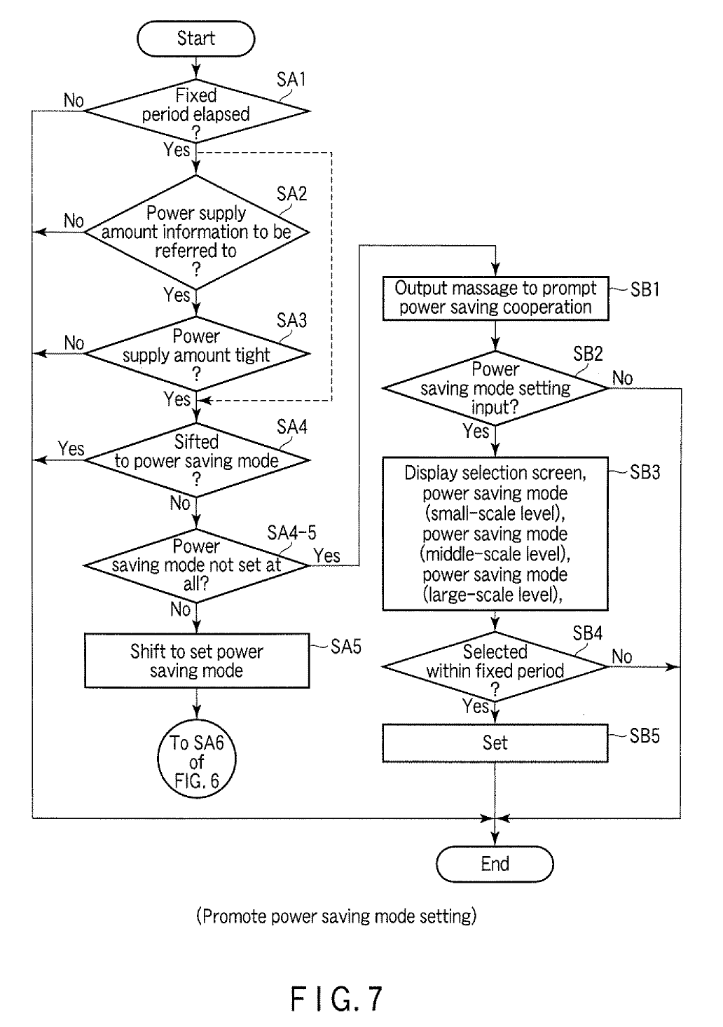

FIG. 6 shows an example condition of the transition to the power saving mode set, for example, as a predetermined period (as another example, a period of power-on is possible). The display 240 determines whether the predetermined period has elapsed (Step SA1). This determination may be performed, for example, by monitoring the output from the timer 330 by means of the timing determination module 410. If the predetermined period has elapsed, it is determined whether the amount of power supply is a determination factor to shift to the power saving mode (Step SA2). The user may preset whether information on the amount of power supply is to be referred or not. The set information has been stored in the power saving mode setting storage module 430. Now, if the amount of power supply is the reference information, it is determined whether the amount of power supply is tight (Step SA3).

The information of whether the amount of power supply is tight is transmitted, for example, from the power company server 102. If the amount of power supply is tight, it is checked whether the display device has already shifted into the power saving mode (Step SA4). If the display 240 has already shifted into the power saving mode, the processing ends, but if it has not shifted yet, the processing shifts into the preset power saving mode (Step SA5).

If the amount of power supply has been omitted from the reference information, the display 240 jumps from Step SA1 to Step SA4 (refer to a dot line).

After transition to the power saving mode, the display 240 issues a message that the display device is currently shifting into the power saving mode, and that the display device may confirm the power saving mode during shifting. That is, a display of “it may be confirmed that the mode is now in shifting into power saving mode, and types of power saving modes may be confirmed” can be displayed on the display 240 (Step SA6).

Therefore, the viewer may perform the confirmation operation in order to confirm what power saving mode will be executed (step SA7). This operation displays the states of a set plurality of types of power saving modes (Step S8). If the power saving mode has been changed, added or reduced, the display device shifts into the changed power saving mode to store the latest power saving mode setting information in the setting storage module 430 (Steps SA9 and SA10). If the power saving mode has not been changed, added and reduced, the current power saving mode is continued (Step SA11). The processing from Step SA6 to Step SA10 is the same as that shown in FIG. 2.

As regards the condition of shifting into the power saving mode, setting a case, in which the amount of power supply has become small after the elapse of the predetermined period as mentioned above, a case in which a commercial message is on-air, a case in which the user watches a program not usually watched, and a case in which a video is transmitted from a video recording and reproducing device, can be used.

If the amount of power supply is relieved (Step SA12), it is checked whether the power saving mode has been executed (Step SA13). If the power saving mode has not been executed, the processing ends; however, if the power saving mode has been executed, the display 240 displays a message confirming that the power saving is now in execution, and the power saving mode being in execution should be continued. Namely, the display 240 displays “Power saving mode is in execution” and “amount of power supply is relieved”, “Power saving mode should be maintained continuously?” (Step SA14). If the power saving mode is continued (No, Step SA15), the display 240 displays the state of the power saving mode (SA8), proceeds to an operation phase such as a change, addition, and reduction (Step SA9) to perform the same processing with the before expressed

The power saving setting may be displayed in response to supply information of power generation such as solar light power generation and wind power generation at home. The power saving setting may be displayed in response to supply information of the power company in addition to the power generation at home.

Further, FIG. 7 shows a flowchart of operations of another embodiment of the invention. In the flowchart of FIG. 7, Step SA4a and Steps SB1-SB5 are added to the flowchart in FIG. 6. Therefore, the following will explain these added Steps.

The extent of the setting of the power saving mode is determined in Step SA4-5. In a case in which the power saving mode is not set, or set to a small extent (e.g., an extent of one or two items), a message is output in order to prompt power saving cooperation (Step SB1).

Here, if an operation (e.g., operation of “OK” button) to set the power saving is conducted by the viewer; the display device displays the power saving mode table. For example, the processing shifts to the flowchart shown in FIG. 2. Or, a power saving mode may be selected among a preset plurality of types of power saving modes as shown in FIG. 7 (Step SB3). As regards the plurality of types of power saving modes, there may be, for example, small-scale, middle-scale and large-scale power saving modes, and any one of them may be selected. If this selection is executed within a predetermined period, the setting information of the selected power saving mode is stored in the setting storage module 430.

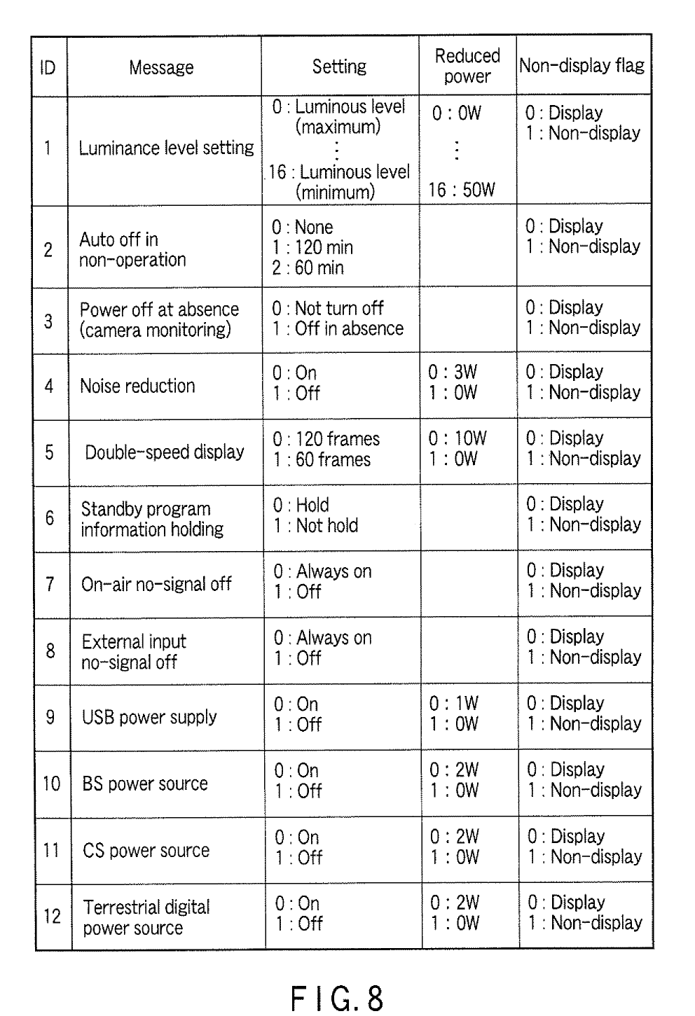

FIG. 8 shows a table of an example of a plurality of types (12 types) of power saving modes. In message columns, a various elements of the power saving are shown. In setting columns, symbols (0 or 1) selecting whether to turn on or off the power saving mode, and levels of the power saving modes are shown. In columns of consumption or reduced power, the differences between the case in which power saving has been performed and the case in which the power saving has not been performed are described. Flag selection columns which decide whether the setting situations of the power saving modes are displayed or not displayed are provided. The flag selection columns are used for deciding whether the power saving mode which has been set once should be displayed from now.

The small-scale, middle-scale, and large-scale power saving modes shown in Step SB3 in FIG. 7 are prepared, for example, by combining a plurality of power saving modes from the table. Namely, the setting information of the small-scale, middle-scale and large-scale of the power saving mode are made in which plurality of items of power saving mode setting information are grouped, respectively.

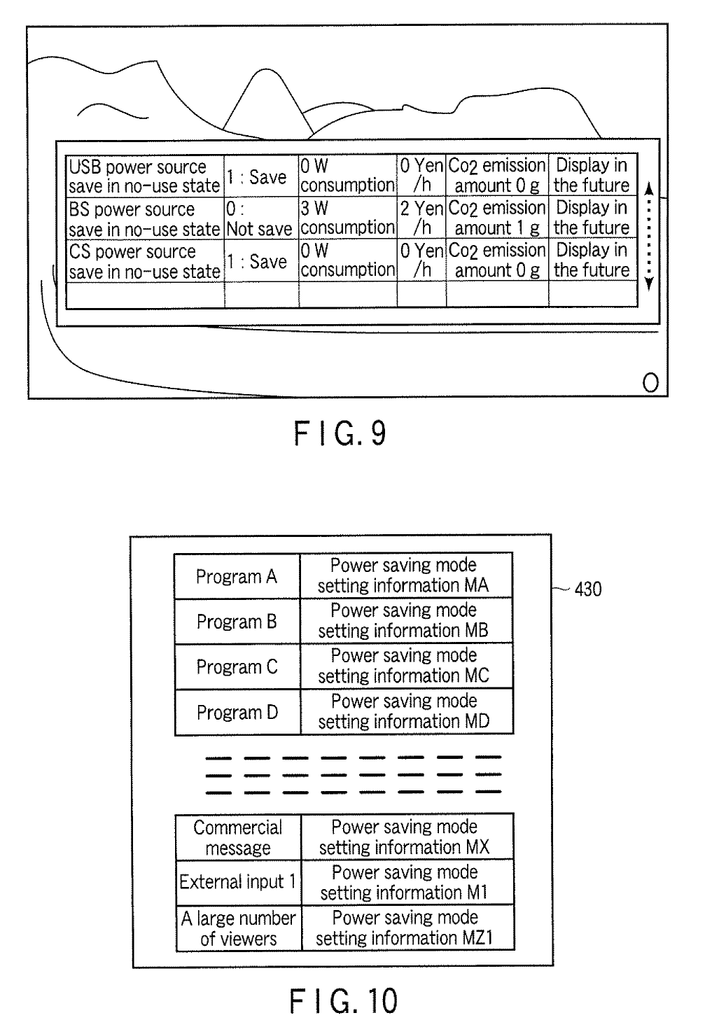

FIG. 9 shows aspects in which the table shown in FIG. 8 is partially displayed. FIG. 9 shows aspects “(8) upon no external input signal, power, for example, of an external interface and a recognition unit are lowered”, “(9) upon no use, USE power is turned off”, and “(10) upon no use, BS tuner power is turned off” are set as the power saving mode in the table. In this case, electricity rates, amounts of power supply, and amounts of CO₂ may be displayed all together. The electricity rates may be calculated in addition to rate by a time-based rate. Further, power saving setting of equipment (e.g., an air conditioner) connected via a network, etc., may be displayed. Thus, the power saving function may be automatically effected, and the frequency of use of the power saving setting by the user is increased. It is also able to automatically notify to the user that the power saving setting is of which the power saving is disabled. The user may set the power saving setting or may not set it depending on the user's taste and surrounding conditions.

The invention is not limited to the aforementioned embodiments. In a case where the viewer sets the power saving mode, the setting information as well as the corresponding-program information may be stored. When the program corresponding to the program information has started, the display 240 may shift the mode into the power saving mode concerned.

FIG. 10 shows an aspect in which power saving mode setting information items MA, MB, MC, MD are associated with programs A, B, C, D, respectively. FIG. 10 shows an aspect in which power saving mode setting information MX is set for a commercial message. FIG. 10 shows an aspect in which power saving mode setting information M1 is set for an external input 1. FIG. 10 shows an aspect in which power saving mode setting information MZ1 is set for a large number of viewers. This setting has a great effect for selecting the power saving mode among the plurality of types of power saving modes in response to the viewer's taste.

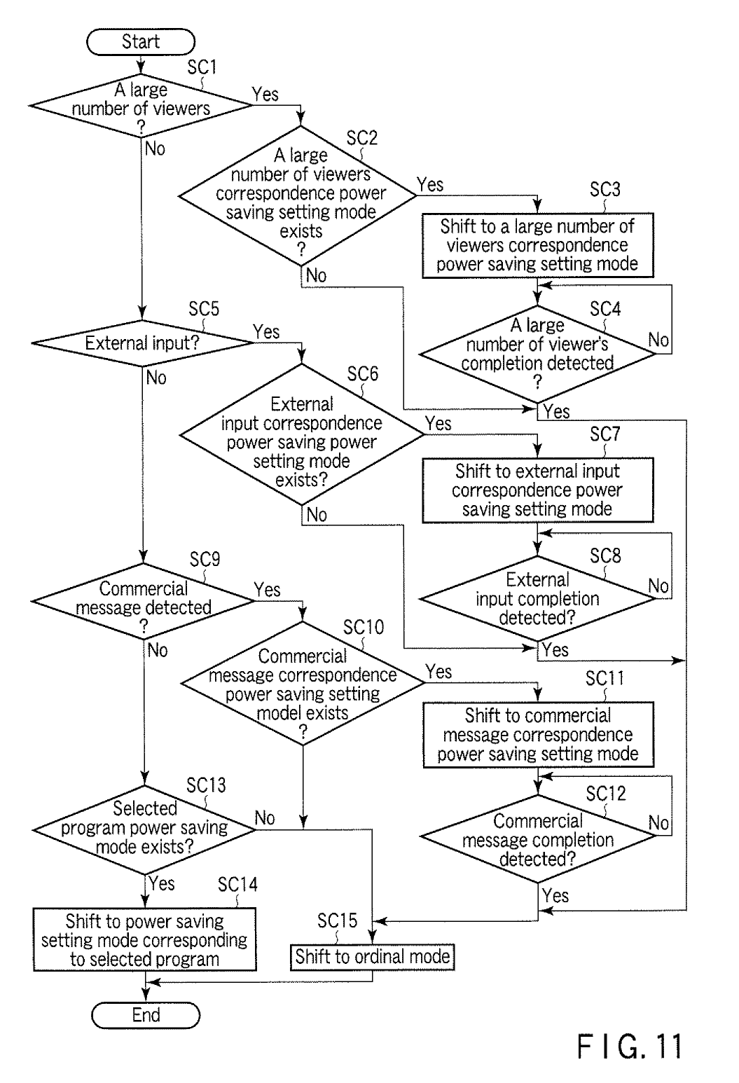

FIG. 11 shows a flowchart illustrating operations for using the power saving mode setting information shown in FIG. 10.

It is determined whether or not a large number of viewers (e.g., three to five or more viewers) are present (Step SC1). If the power saving mode setting information (e.g., lower volume, lower luminous level) for a large number of viewers is acquired (Step SC2), the display device shifts into the power saving mode on the basis of the corresponding-power saving mode setting information (Step SC3). After the viewing by the large number of viewers has stopped, the power saving mode ends (Step SC4).

It is determined whether an external input has been input or not (Step SC5). If the power saving mode setting information for the external input has been existed (Yes, Step SC6), the display 240 shifts into the power saving mode on the basis of the power saving mode setting information concerned (Step SC7). After completing the external input (Step SC8), the flowchart ends the power saving mode (Step SC15).

When the start of the commercial message broadcasting has been detected (Step SC9), if the power saving mode setting information corresponding to the commercial message broadcasting exists (Step SC10), the display device executes the power saving mode on the basis of the power saving mode setting information concerned (Step SC11). After detecting the end of the commercial message broadcasting (Step SC12), the flowchart ends the power saving mode (Step SC15).

When the program to be viewed has been selected, it is determined whether or not the power saving mode setting information for the selected program exists or not (Step SC13). If the power saving mode setting information for the selected program does not exist, the flowchart ends. If the power saving mode information therefor exists, the display device executes the power saving mode on the basis of the power saving mode setting information (Step SC14).

Further, when starting the power saving mode, the display 240 outputs the message such as “power saving mode is in execution and types of power saving mode may be confirmed” as shown in FIG. 5A. However, such a message may be prohibited to be displayed, for example, when there are a large number of viewers. This is because that the intention of a change in setting of the power saving mode by a certain viewer brings other viewers into a situation in which the change is not necessary for other viewers.

If the display device has a learning function of the number of times of viewing of the programs to be viewed, reception viewing of a program with a large number of viewing times (e.g., 10 times or more) has been started, and also the power saving mode for this program has been set, the display device need not output the message such as “power saving mode is in execution and types of power saving mode may be confirmed” shown in FIG. 5A. Conversely, if the number of viewing times of a program to be viewed is small, the message such as “power saving mode is in execution and types of power saving mode may be confirmed” shown in FIG. 5A may be output.

In FIG. 6, while the case in which the state check for the power saving mode is performed after the passage of the predetermined time-period has been described, the predetermined time-period may be variable. For instance, in a hot time-period in summer, or a cold time-period in winter, the predetermined time-period may be shortened, and the power saving state may be checked frequently.

Further, the display device may have a function to cancel all items of the power saving mode setting information at one time. Conversely, the display device may have a function to set the display device so that all the power saving modes can be executed.

The invention may be mounted on any equipment with a display. For instance, the equipment may be a personal computer, a portable reception display device, etc.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the total of the constituent elements shown in the embodiments mentioned above. Further, the constituent elements over different embodiments may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a display output module configured to output information on setting states stored in a memory in response to an operation input, the setting states being a plurality of types of power saving modes;
a change control module configured to select and change the types of power saving modes in response to the operation input; and
an execution module configured to execute the types of power saving modes when a predetermined condition is met.

2. The device of claim 1, further comprising:
a display processing module configured to output a message for showing a power saving mode execution state when the types of power saving modes are executed.

3. The device of claim 2, wherein the message showing the power saving mode execution state is information for further confirming types of power saving modes.

4. The device of claim 1, wherein the types of power saving modes are composed of classified groups of a plurality of items of power saving mode setting information.

5. The device of claim 1, wherein information on the types of power saving modes are stored together with program information, commercial message information, external input information, and viewer information.

6. The device of claim 2, wherein information on at least one of the types of power saving modes, a plurality of items of power saving mode setting information, and a power saving mode execution state are displayed during a commercial message period.

7. The device of claim 2, wherein information on at least one of the types of power saving modes, a plurality of items of power saving mode setting information, and a power saving mode execution state are displayed during an external input.

8. The device of claim 2, wherein information on at least one of the types of power saving modes, a plurality of items of power saving mode setting information, and a power saving mode execution state are displayed when the number of viewers is small.

9. A control method for a display device configured to set a power saving mode to a control unit to execute the power saving mode, comprising:
displaying setting states stored in a memory in response to an operation input, the setting state being a plurality of power saving modes;
selecting and changing the types of power saving modes in response to the operation input; and
executing the types of power saving modes when a predetermined condition is met.

10. The method of claim 9, configured to output a message showing execution states of power saving modes when the types of power saving modes are executed.
